(19) United States
(12) Patent Application Publication
(10) Pub. No.: US 2025/0010832 A1
(43) Pub. Date: Jan. 9, 2025

(54) PNEUMATIC VALVE SYSTEM

(71) Applicant: ZF CV Systems Global GmbH, Bern (CH)

(72) Inventors: Michael Haverkamp, Hannover (DE); Mirko Brütt, Springe (DE)

(73) Assignee: ZF CV Systems Global GmbH, Bern (CH)

(21) Appl. No.: 18/761,924

(22) Filed: Jul. 2, 2024

(30) Foreign Application Priority Data
Jul. 3, 2023 (DE) 10 2023 206 299.2

(51) Int. Cl. B60T 13/68; B60T 7/20; B60T 13/26; B60T 13/66

(52) U.S. Cl. CPC B60T 13/683; B60T 7/20; B60T 13/263; B60T 13/662

(57) ABSTRACT

The invention relates to a pneumatic valve system (5) for a braking system of a towing vehicle. The pneumatic valve system (5) comprises a valve block (28) comprising a supply pressure inlet (29), a towing vehicle supply pressure outlet (30) and a towing vehicle control pressure outlet (32), as well as a control valve (6), a redundancy valve (7), and a brake valve (10). The pneumatic valve system (5) permits a redundant pressure supply of a brake cylinder of a parking brake of the towing vehicle by connecting the valves and the supply pressure outlet and outlets to one another in a very compact and stable manner.

### RELATED APPLICATIONS

This application claims the benefit and right of priority under 35 U.S.C. § 119 to German Patent Application no. 10 2023 206 299.2, filed on 3 Jul. 2023, the contents of which are incorporated herein by reference in its entirety.

### FIELD OF THE DISCLOSURE

The invention relates to a pneumatic valve system for a brake system of a towing vehicle.

### BACKGROUND

JP 2004217009 A2 teaches a device for disengaging a negative parking brake in order to quickly disable the braking force in emergencies, e.g., in the event of damage to a hydraulic circuit and failure of a switch. The citation proposes a release device for a negative parking brake that is installed in a brake system with two hydraulic circuits for supplying pressurized oil from a hydraulic pump to a service brake. The release device comprises two electromagnetic switching valves for connecting and interrupting pressurized oil that enters the negative parking brake from the respective hydraulic circuits. The release device further comprises two actuating sections for outputting a connection or interruption command of the pressurized oil to corresponding electromagnetic selection valves. In addition, the release device comprises a high-pressure selection valve for selecting a high-pressure-side pressurized oil in pressurized oils that flow from the respective oil pressure circuits to the negative parking brake.

### SUMMARY

An object of the present invention can be seen in providing a redundant pressure supply in a pneumatic brake system in a particularly compact and stable manner. The object is achieved by a pneumatic valve system as variously disclosed herein. Further advantageous variations and embodiments will be apparent in light of the following description and the figures.

The present invention proposes a valve structure or a valve arrangement for a control system of a pneumatic parking brake. The valve structure allows a redundant and thus safe compressed air supply to a brake cylinder of a parking brake via a redundancy valve if the control valve fails. Valves, connections or lines, and ports (inlets and outlets) required for this purpose can in particular be arranged in or on a valve block. This integration into a valve block provides a compact design and only requires a way to fasten the valve block (with appropriate valve block strength). It is no longer necessary to install a separate bracket in the vehicle for each of the valves. This saves further installation space since the dimensions of the individual valves and their required mounting options are no longer decisive and a more compact design is possible compared to the sum of the individual devices. Furthermore, stability is increased compared to individual valves, which are usually not stable enough to be fastened together with other devices (risk of breakage).

In this sense, an inventive pneumatic valve system is provided for a braking system of a towing vehicle. The pneumatic valve system comprises a valve block that comprises a supply pressure inlet, a towing vehicle supply pressure outlet, and a towing vehicle control pressure outlet. The pneumatic valve system further comprises a first directional control valve adapted as a control valve, a second directional control valve adapted as a redundancy valve, and a third directional control valve adapted as a brake valve. The valve block in particular forms channels in its interior that connect the supply pressure inlet to the directional control valves, to the towing vehicle supply pressure outlet and to the towing vehicle control pressure outlet, as well as to equivalent outlets for a trailer control valve system described below. The directional control valves are in particular arranged in the valve block or on an outer surface of the valve block. The supply pressure inlet and the supply and control pressure outlets are also in particular arranged on an outer surface of the valve block. The valve block can for example be formed by a casting.

Supply compressed air can be supplied to the pneumatic valve system via the supply pressure inlet. The supply compressed air can be fed via the supply pressure outlets in the direction of at least one brake cylinder of a parking brake of the towing vehicle or a trailer brake. “Supply compressed air” is in particular understood to mean air that is under a sufficiently high actuating pressure in order to build up a sufficiently high disengagement pressure in the brake cylinder of the parking brake of the towing vehicle such that the parking brake of the towing vehicle is disengaged, whereupon the parking brake does not lock a wheel of the towing vehicle. Furthermore, the compressed air supply can be used to actuate the trailer brake (directly or inversely). The pneumatic valve system can output control air via the control air outlets, in particular to a towing vehicle relay valve or to the trailer control valve system. “Control air” in particular refers to air that is under a sufficiently high control pressure to move a valve actuator of the towing vehicle relay valve of the brake system of the towing vehicle or the trailer control valve system. The control pressure of the control air is in particular lower than a supply pressure of the supply compressed air. The control pressure is in particular not sufficient to build up the disengagement pressure in the brake cylinder.

The supply pressure inlet is adapted to be connected to a compressed air source of the brake system. The feature “connected” in particular means that the respectively connected elements are connected to each other to be pneumatically conductive, i.e., that compressed air can flow from one element to the other element and, if necessary, vice versa. The pressurized medium source is adapted to store pressurized compressed air. The pressurized medium source (e.g., a tank or an accumulator) is adapted to output the stored compressed air in order to actuate the brake cylinder of the towing vehicle and/or the trailer brake of the trailer vehicle towed by the towing vehicle. When the ignition of the towing vehicle is switched on, a drive motor of the towing vehicle can cause a filling of the pressurized medium source, e.g., by driving a compressor that intakes, compresses and supplies air to the pressurized medium source.

The brake valve is connected firstly, in particular upstream, via a shuttle valve to the control valve and to the redundancy valve and, secondly, in particular downstream, to the towing vehicle control pressure outlet. The supply pressure inlet is connected to the control valve and to the redundancy valve such that compressed air can flow from the compressed air source via the control valve or the redundancy valve and downstream via the brake valve to the towing vehicle control pressure outlet. Compressed air can still flow via the redundancy valve and be guided via the shuttle valve and the brake valve to the towing vehicle control pressure outlet if a control of the control valve fails, thus preventing compressed air flow via the control valve. This enables redundant control of the parking brake via the towing vehicle control pressure outlet.

The supply pressure inlet is still connected to the towing vehicle supply pressure outlet. The towing vehicle supply pressure outlet is further adapted to be connected to a supply pressure inlet of a towing vehicle relay valve for actuating a brake cylinder of the towing vehicle. The ability to connect to the towing vehicle relay valve allows small pilot valves to be used to control the external relay instead of standard large diameter valves, resulting in improved packaging and cost reduction. In addition, the towing vehicle control pressure outlet is adapted to be connected to a control pressure inlet of the towing vehicle relay valve. The pneumatic valve system can thus in a particularly compact and stable manner provide at its valve block all ports necessary to supply a relay valve for actuating a brake cylinder with compressed air and control air.

In the event of a break or tear of a connection line between the trailer vehicle supply pressure outlet and a supply pressure inlet of the trailer control valve system or another line connected to the trailer control valve system, this can lead to a leakage in the compressed air supply of the brake cylinders of the towing vehicle. As a result, the compressed air pressure applied to the towing vehicle supply pressure outlet may drop to such a low value that it would automatically actuate the parking brake system. In order to avoid this, a check valve can maintain the pressure in the parking brake system of the towing vehicle such that the towing vehicle can continue to drive for a short time-without the parking brake being actuated-until the vehicle can come to a safe stop. In this sense, a further embodiment provides that the valve block comprises a check valve that connects the supply pressure inlet to the control valve and the redundancy valve such that compressed air can flow from the compressed air source to the towing vehicle control pressure outlet via the control valve or the redundancy valve and downstream via the brake valve.

Furthermore, the check valve connects the supply pressure inlet to the towing vehicle supply pressure outlet and isolates the towing vehicle supply pressure outlet from the supply pressure inlet in the opposite direction of flow. In particular, an inlet of the check valve is connected to the supply pressure inlet and an outlet of the check valve to the towing vehicle supply pressure outlet. The check valve causes compressed air coming from the compressed air source to flow through the supply pressure inlet of the valve block and the check valve to the towing vehicle supply pressure outlet of the valve block. On the other hand, compressed air in particular coming from the towing vehicle supply pressure outlet is prevented from flowing via the check valve to the supply pressure inlet. The same applies to compressed air coming from the direction of the control valve and the redundancy valve. Compressed air can still flow via the redundancy valve and be guided via the shuttle valve and the brake valve to the towing vehicle control pressure outlet if a control of the control valve fails, thus preventing compressed air flow via the control valve. This enables redundant control of the parking brake via the towing vehicle control pressure outlet. The check valve also allows the pneumatic valve system to be integrated into a pressure circuit (“Circuit 3”) of a brake system together with the supply of the trailer control valve since the parking brake circuit is secured by the check valve in the supply. The check valve is in particular firstly arranged between the supply pressure inlet and secondly between the towing vehicle supply pressure outlet, the control valve, and the redundancy valve.

A further embodiment provides that the valve block comprises a trailer supply pressure outlet and a trailer vehicle control pressure outlet, wherein the trailer vehicle supply pressure outlet is connected to the supply pressure inlet by bypassing the check valve, and wherein the trailer vehicle supply pressure outlet is adapted to be connected to a supply pressure inlet of a trailer control valve system for the trailer brake of the trailer vehicle towed by the towing vehicle. The trailer vehicle control pressure outlet is firstly connected—in particular upstream—via the shuttle valve to the control valve and to the redundancy valve, and is secondly adapted to be connected (in particular downstream) to a control pressure inlet of the trailer control valve system. In this embodiment, compressed air can still flow via the redundancy valve and be guided via the shuttle valve and the brake valve to the trailer vehicle control pressure outlet if a control of the control valve fails, thus preventing compressed air flow via the control valve. Thus, there is also redundancy for the trailer brake. By additionally integrating the trailer vehicle supply pressure outlet and the trailer vehicle control pressure outlet into the valve block, the installation space can be reduced again, while at the same time increasing the mounting stability of the valves.

In particular, all pneumatic ports (inlets and outlets) can be placed on the same side of the valve block. This allows even smaller installation spaces compared to the installation of individual components. In this sense, a further embodiment provides that the supply pressure inlet, the towing vehicle supply pressure outlet, the towing vehicle control pressure outlet, the trailer vehicle supply pressure outlet and the trailer vehicle control pressure outlet are arranged on one and the same outer surface of the valve block.

In particular the control valve of the redundancy valve and the brake valve are preferably controlled electronically in order to ultimately also enable electronic control of the parking brake of the towing vehicle and the trailer brake of the trailer vehicle. This electronic control does not require any additional cables or lines or valves within an operator cab of the towing vehicle. This reduces the assembly effort and enables noise reduction. The valve package is controlled via an external control unit that communicates from the cab over a CAN bus or existing cabling with the valve system to actuate the parking brake. This also permits use for operator-independent assistance and safety functions, such as those required for autonomous vehicles. In this sense, one embodiment provides that the pneumatic valve system further comprises an electronic control unit connected via electronic control lines to the control valve, the redundancy valve, and the brake valve.

The control valve, the redundancy valve, and the brake valve are solenoid valves, each of which has an electromagnet. The electronic control unit is adapted to control the electromagnets such that the control valve and the redundancy valve are transferred from a mechanically preloaded closed state to an open state and vice versa, and the brake valve is transferred from a mechanically preloaded open state to a closed state and vice versa. In other words, the control valve and the redundancy valve are mechanically preloaded (“normally closed”), in particular in a closed state. If the control valve and the redundancy valve are in the closed state, compressed air cannot flow via the control valve and the redundancy valve from the compressed air source to the shuttle valve. In particular, compressed air coming from the shuttle valve can also escape to a non-pressurized environment via the control valve and the redundancy valve if the control valve and the redundancy valve are in the closed state.

The control valve and the redundancy valve can be transferred to an open state against the mechanical pretension. For this purpose, the control valve and the redundancy valve in particular comprise an electromagnet that can be energized such that a magnetic field is established that moves a valve actuator of the control valve and the redundancy valve to an open switching position against the mechanical pretension, which corresponds to an open position of the control valve and the redundancy valve. The electromagnets can in particular be energized by an electronic control unit of the brake system. For this purpose, the electronic control unit can be connected to the electromagnets of the control valve and the redundancy valve via electronic control lines. If the control valve and the redundancy valve are in the open state, compressed air can flow via the control valve and the redundancy valve from the compressed air source to the shuttle valve.

The brake valve is in particular mechanically pretensioned in an open state (“normally open”). When the brake valve is in the open state, compressed air flows from the shuttle valve via the brake valve to the towing vehicle control pressure outlet. The brake valve can be transferred to a closed state against the mechanical pretension. For this purpose, the brake valve in particular comprises an electromagnet that can be energized such that a magnetic field is established that moves a valve actuator of the brake valve to a closed switching position against the mechanical pre-load, which corresponds to a closed position of the brake valve. If the brake valve is in the closed state, compressed air coming from the towing vehicle control pressure outlet can escape directly to the non-pressurized environment via the brake valve.

Furthermore, the valve system can permit a test function of the parking brake, according to which the operator wants to check whether the full vehicle trailer combination comprised of the towing vehicle and trailer vehicle can be held on a gradient with only the parking brakes of the towing vehicle. The operator can enable this function via an interface in the cab. The control valve and the redundancy valve remain actuated for this purpose, i.e., they remain in their open state such that the trailer brake remains disengaged. The brake valve is switched to the closed position. As a result, the pressure in the spring-loaded brake cylinders of the towing vehicle is relieved and the parking brakes are enabled such that a braking maneuver is carried out by means of the towing vehicle. In this sense, a further embodiment provides that the electronic control unit—after having received a brake test request—is adapted to control the electromagnets of the control valve and the redundancy valve such that the control valve and the redundancy valve are transferred to the open state. Furthermore, after having received the brake test request, the electronic control unit is adapted to control the electromagnets of the brake valve such that the brake valve is transferred to the closed state such that the trailer brake is disengaged and the parking brake of the towing vehicle is engaged.

On the one hand, the pneumatic valve system can be transferred to a so-called unactuated state. The supply pressure inlet is supplied with compressed air or is pressurized by the air supply system of the towing vehicle. As a result, the towing vehicle supply pressure outlet and the trailer vehicle supply pressure outlet are also supplied with compressed air or are pressurized. On the other hand, the towing vehicle control pressure outlet and the trailer vehicle pressure outlet are not supplied with compressed air or not pressurized by moving the control valve and the redundancy valve to the closed state. An inverted function of the brake cylinder and the trailer brake results in an engaged parking brake effect. In this sense, a further embodiment specifies that the electronic control unit is adapted to control the electromagnets of the control valve and the redundancy valve such that the control valve and the redundancy valve are transferred to the closed state such that compressed air cannot flow from the pressurized medium source via the control valve or the redundancy valve and downstream firstly to trailer vehicle control pressure outlet and secondly via the brake valve to the towing vehicle control pressure outlet, thus allowing the parking brake of the towing vehicle and the trailer brake to be engaged.

On the other hand, the pneumatic valve system can be transferred to a so-called actuated state. The supply pressure inlet is supplied with compressed air or is pressurized by the air supply system of the towing vehicle. As a result, the towing vehicle supply pressure outlet and the trailer vehicle supply pressure outlet are also supplied with compressed air or are pressurized. The towing vehicle control pressure outlet and the trailer vehicle pressure outlet are supplied with compressed air or are pressurized by moving the control valve and the redundancy valve to the open state and leaving the brake valve in its mechanically preloaded open state. The inverted function of the brake cylinder and the trailer brake results in a disengaged parking brake effect. In this sense, a further embodiment specifies that the electromagnets of the control valve and the redundancy valve are controlled such that the control valve and the redundancy valve are transferred to the open state such that compressed air can flow from the pressurized medium source via the control valve or the redundancy valve and downstream firstly to the trailer vehicle control pressure outlet and secondly via the brake valve to the towing vehicle control pressure outlet, thus allowing the parking brake of the towing vehicle and the trailer brake to be disengaged.

Furthermore, components can be standardized such that the same solenoid valve is used three times. In this sense, a further embodiment provides that the control valve, the redundancy valve, and the brake valve are identical parts. The normally closed state (control valve, redundancy valve) and normally open state (brake valve) can be realized by mechanical properties within the valve block.

It can also be provided that all three solenoid valves are actuated as soon as the parking brake system is switched to purge air from the trailer control valve and the spring-loaded brake cylinders. As a result, either the control valve or the redundancy valve purges the control pressure for the trailer control valve system and the brake valve purges the lines for actuating the relay valve and thus the spring-loaded brakes of the towing vehicle. The advantage is that existing valves can be used to increase the response behavior of the system. In this sense, a further embodiment provides that the electronic control unit is adapted to control the electromagnets of the control valve and the redundancy valve such that the control valve and the redundancy valve are transferred to the closed state such that the trailer vehicle control pressure outlet is connected to a non-pressurized environment via the control valve or the redundancy valve. The electronic control unit is further adapted to control the electromagnets of the brake valve such that the brake valve is transferred to the closed state such that the towing vehicle control pressure outlet is connected to the non-pressurized environment.

The towing vehicle relay valve can also be used together with a quick purge valve. In order to increase the speed of the pressure relief of larger volumes (e.g., in the area of the spring-loaded brake cylinders of the towing vehicle), the use of such a quick purge valve can be advantageous. The quick purge valve is adapted to release compressed air from the brake cylinder directly to the non-pressurized environment. The quick purge valve can for example be of the one-way type. The quick purge valve is in particular arranged between a relay valve and a brake cylinder of the parking brake of the towing vehicle or within said relay valve. Since quick purge valves have large air passages and there is a possibility to position these valves near the pressurized volume, quick purging is possible without being restricted by small flow diameters of other valves or long lines between these. In this sense, a further embodiment provides that a quick purge valve is connected to the towing vehicle relay valve, wherein the quick purge valve is adapted to release compressed air from the brake cylinder directly to the non-pressurized environment.

### BRIEF DESCRIPTION OF THE DRAWINGS

Exemplary embodiments of the invention are explained in more detail below using the schematic drawing, wherein the same or similar elements are provided with the same reference symbol. The figures show in

FIG. 1: a top view of a part of a brake system for a towing vehicle and a trailer vehicle,

FIG. 2: details of an inventive pneumatic valve arrangement of the brake system according to FIG. 1 and

FIG. 3: design details of the pneumatic valve arrangement according to FIG. 2,

### DETAILED DESCRIPTION

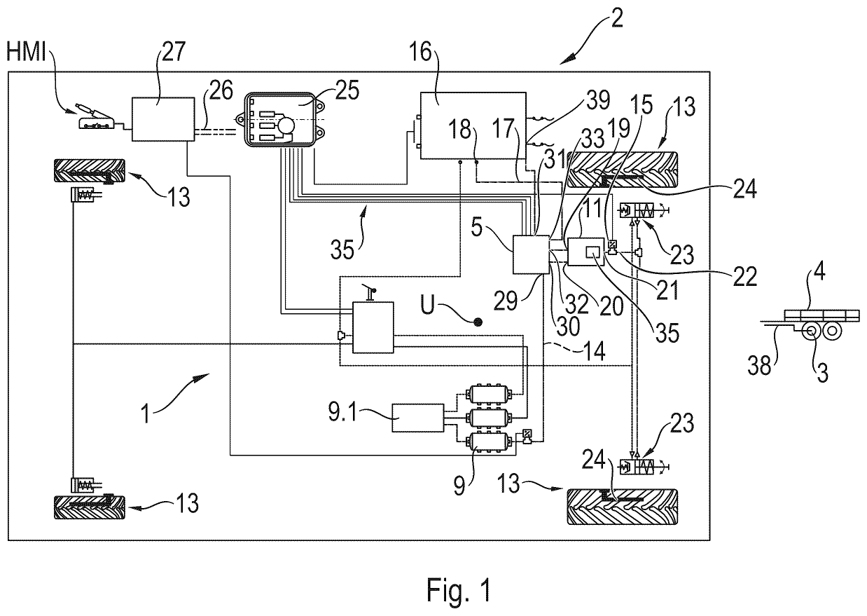

FIG. 1 shows a part of a brake system 1 for a not depicted towing vehicle 2. The towing vehicle 2 is, for example, an agricultural commercial vehicle, in particular a tractor. The brake system 1 in particular performs a parking brake or permanent brake function (“parking brake function”) of wheels 13 of the towing vehicle 2 and a trailer brake 3 (only indicated in FIG. 1) of a trailer vehicle 4. The functions described in more detail below can be a part of a tractor-brake system platform. This ensures the safe operation of the brake system 1 in various failure scenarios.

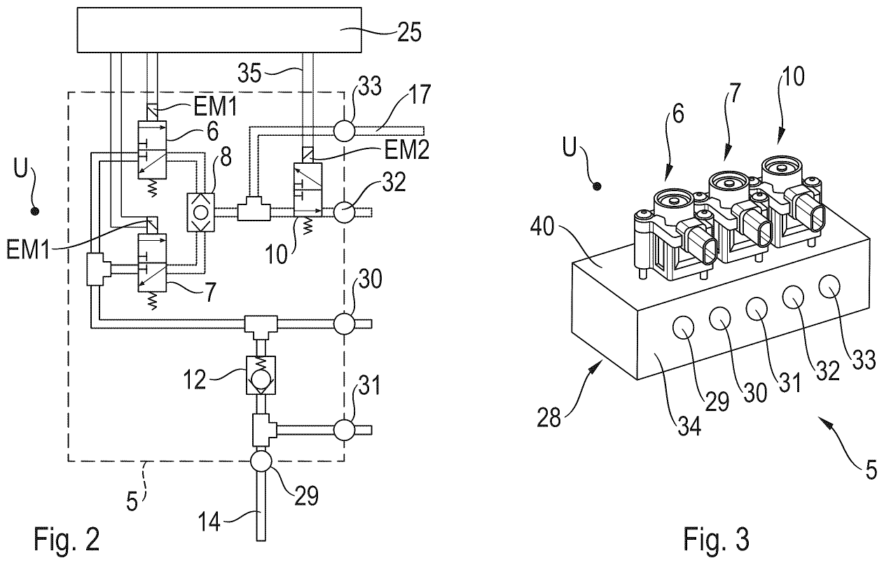

The brake system 1 comprises an electronically controllable parking brake module in the form of a pneumatic valve arrangement 5, the details of which are shown by FIG. 2 and FIG. 3. The pneumatic valve arrangement 5 comprises a first 3/2 solenoid directional control valve adapted as a control valve 6, a second 3/2 solenoid directional control valve adapted as a redundancy valve 7, a pressure-controlled shuttle valve 8, a 3/2 solenoid directional control valve adapted as a brake valve 10, and a check valve 12. A towing vehicle relay valve 11 and a pressure sensor 15 are arranged downstream of the pneumatic valve arrangement 5. The control valve 6 and the redundancy valve 7 of the parking brake module 5 are supplied via a supply line 14 and via the check valve 12 by a pressurized medium source 9 on the inlet side with pneumatic pressurized media in the form of compressed air. The towing vehicle relay valve 11 is also supplied by the pressurized medium source 9 with compressed air on the inlet side via the supply line 14 and via the check valve 12. The pressurized medium source 9 can comprise a compressor 9.1 that can be driven by a drive machine (not shown) or by a motor (e.g., an internal combustion engine or an electric motor) of the towing vehicle 2 when an ignition of the towing vehicle 2 is switched on.

In a parallel pneumatic circuit, the control valve 6 and the redundancy valve 7 are each connected to the pressurized medium source 9 on the input side via the supply line 14 and the check valve 12. The shuttle valve 8 is respectively connected at the inlet side to an outlet of the control valve 6 and the redundancy valve 7. On the outlet side, the shuttle valve 8 is connected to an inlet of the brake valve 10 and, via a connection line 17, to a first inlet 18 (control pressure inlet) of a trailer control valve system 16. The respectively higher pressure of the two valves 6, 7 can thus be output via the outlet of the shuttle valve 8 in the direction of the brake valve 10 and the first inlet 18 of the trailer control valve system 16.

A control pressure inlet 19 of the relay valve 11 is connected to an outlet of the brake valve 10. A supply pressure inlet 20 of the relay valve 11 is connected to the pressurized medium source 9 via the check valve 12 and the supply line 14. A pressure outlet 21 of the relay valve 11 is connected via a brake cylinder line 22 to two brake cylinders 23 for actuating one parking brake 24 each. The pressure sensor 15 is arranged in the brake cylinder line 22 and measures the pressure prevailing therein, which can be considered representative for a pressure within the brake cylinder 23. The pressure sensor 15 transmits the measured pressure to an electronic control unit 25 of the brake system 1. The electronic control unit 25 is further connected via electronic control lines 35 to the control valve 6, to the redundancy valve 7 and to the brake valve 10. For the sake of clarity, only one of the electronic control lines is provided with a reference symbol in FIG. 2. In the region of the pneumatic valve arrangement 5, the electronic control lines 35 can in particular extend in and/or on a valve block 28 described in greater detail below.

In the depicted exemplary embodiment, the control valve 6 and the redundancy valve 7 are identical parts, which is however not mandatory. The brake valve 10 can also be designed in the same way as the control valve 6 and/or the redundancy valve 7. A valve actuator of the control valve 6 and the redundancy valve 7 are preloaded in a valve housing (not shown) by a spring element in a closed position (“normally closed”), which corresponds to a closed state of the control valve 6 and the redundancy valve 7 shown in FIG. 2. When the control valve 6 and the redundancy valve 7 are in the closed state, no compressed air is directed from the pressurized medium source 9 via the control valve 6 and the redundancy valve 7 in the direction of the shuttle valve 8, the brake valve 10, which is further arranged downstream, and a towing vehicle control pressure outlet 32 described further below, and in the direction of the towing vehicle relay valve 11, which is arranged further downstream. Thus, no control pressure is applied to the control pressure inlet 19 of the relay valve 11, as a result of which the relay valve 11 does not convey compressed air, which is applied to the supply pressure inlet 20, via the pressure outlet 21 to the brake cylinder line 22. As a result, the brake cylinders 23 are not filled with compressed air such that no disengagement pressure is built up in the brake cylinders 23, thus causing the parking brakes 24 to be or remain engaged. The wheels 13 of the motor vehicle 2 are or remain locked by the parking brakes 24.

The control valve 6 and the redundancy valve 7 have electromagnets EM1, which can be energized such that the valve actuators are moved from the closed position to an open position, which corresponds to an open state of the control valve 6 and the redundancy valve 7. The electromagnet EM1 is energized, or at least controlled, by the electronic control unit 25. When the control valve 6 and the redundancy valve 7 are in the open state, compressed air is directed from the pressurized medium source 9 via the control valve 6 and the redundancy valve 7 and can be fed via the shuttle valve 8 and the brake valve 10 (arranged further downstream) and the towing vehicle control pressure outlet 32 to the control pressure inlet 19 of the relay valve 11. If the control valve 6 fails, the pressure of the redundancy valve 7 can continue to be used if the redundancy valve 7 has not failed. If the redundancy valve 7 fails, the pressure of the control valve 6 can continue to be used if the control valve 6 has not failed.

A valve actuator of the brake valve 10 is preloaded inside its valve housing by a spring element in an open position shown by FIG. 2 (“normally open”), which corresponds to an open state of the brake valve 10. When the brake valve 10 is in the open state, compressed air-which has been directed from the pressurized medium source 9 via the open control valve 6 or the open redundancy valve 7 as well as the shuttle valve 8—is fed via the brake valve 10 to the control pressure inlet 19 of the towing vehicle relay valve 11. In this case, the towing vehicle relay valve 11 conveys compressed air, which is applied to the supply pressure inlet 20, via the pressure outlet 21 to the brake cylinder line 22. Consequently, the brake cylinders 23 are filled with compressed air, which builds up a disengagement pressure in the brake cylinders 23 such that the parking brakes 24 are disengaged. The wheels 13 of the towing vehicle 2 are then no longer locked by the parking brakes 24.

The electronic control unit 25 can control an energizing of an electromagnet EM2 of the brake valve 10 such that the valve actuator of the brake valve 10 is moved from the open position to a closed position, which corresponds to a closed state of the brake valve 10. When the brake valve 10 is in the closed state, compressed air can escape from the brake cylinders 23 via the towing vehicle relay valve 11 and the brake valve 10 to a non-pressurized environment U such that the disengagement pressure is relieved and the parking brake 24 is engaged. The wheels 13 of the towing vehicle 2 are then locked. In this context, it can be said that the valve arrangement 5 has an inverting control characteristic. The parking brakes 24 of the towing vehicle 2 are engaged if no pressure is output via the towing vehicle relay valve 11, and the parking brakes 24 are disengaged if a sufficiently high pressure is output via the towing vehicle relay valve 11, which results in the disengagement pressure within the brake cylinder 23.

Furthermore, the pneumatic valve arrangement 5 allows a test function of the parking brake 24, according to which an operator of the towing vehicle 2 wishes to check whether the full vehicle trailer combination comprised of the towing vehicle 2 and trailer vehicle 4 can be held on a gradient with only the parking brakes 24 of the towing vehicle 2. The operator can enable this function via the human-machine interface HMI in the cab, whereby a brake test request is transmitted to the electronic control unit 25. The electronic control unit 25 then controls the electromagnet EM1 of the control valve 6 and the redundancy valve 7 such that the control valve 6 and the redundancy valve 7 are transferred to the open state such that pressure is applied to the first inlet 18 of the trailer control valve system and the trailer brake 3 remains disengaged.

The trailer brake 3 of the trailer vehicle thus also has an inverted control characteristic. The trailer brake 3 is disengaged or is released when pressure is applied to the first inlet 18 of the trailer control valve system 16, and is engaged or actuated when no pressure is applied to the first inlet 18 of the trailer control valve system 16. The electronic control unit 25 furthermore controls the electromagnet EM2 of the brake valve 10 such that the brake valve 10 is transferred to the closed state. As a result, the pressure in the spring-loaded brake cylinders 23 of the towing vehicle 2 is released via the brake valve 10 to the non-pressurized environment U and the parking brakes 24 are engaged such that a braking action is carried out by means of the towing vehicle 2.

FIG. 1 shows that the electronic control unit 25 of the brake system 1 can be connected via a CAN BUS 26 to an electronic (main) control unit 27 of the towing vehicle 2. In the exemplary embodiment shown, the electronic (main) control unit 27 of the towing vehicle 2 is in particular connected to a human-machine interface HMI in an operator cab of the towing vehicle 2. Using the human-machine interface HMI, an operator or user of the towing vehicle 2 can operate the brake cylinder 23 of the towing vehicle 2 and/or the trailer brake 3 of the trailer vehicle 4. If the parking brakes 24 are to be engaged or actuated in normal operation, i.e., if the electronic control unit 25 is in an active state, the control valve 6 and the redundancy valve 7 are disabled, i.e., transferred to the closed state such that the brake cylinders 23 can be purged via the relay valve 11 and the disabled brake valve 10. When the brake valve 10 is disabled, it is in the open state such that pressurized medium can escape from the brake cylinder 23 via the towing vehicle relay valve 11, the brake valve 10, the shuttle valve 8, the control valve 6 and the redundancy valve 7 to the non-pressurized environment U.

FIGS. 2 and 3 show that the pneumatic valve arrangement 5 comprises a valve block 28, which comprises a supply pressure inlet 29, a towing vehicle supply pressure outlet 30, a trailer vehicle supply pressure outlet 31, a towing vehicle control pressure outlet 32 and a trailer vehicle control pressure outlet 33. In the exemplary embodiment shown by FIG. 3, the supply pressure inlet 29, the towing vehicle supply pressure outlet 30, the towing vehicle control pressure outlet 32, the trailer vehicle supply pressure outlet 31 and the trailer vehicle control pressure outlet 33 are arranged on the same lateral outer surface 34 of the valve block 28. According to FIG. 3, the valve block is for example cuboid-shaped with four lateral outer surfaces 34, wherein the mentioned ports 29 to 33 are arranged on the same lateral outer surface 34. In the exemplary embodiment according to FIG. 3, the control valve 6, the redundancy valve 7 and the brake valve 10 are arranged side-by-side on an upper outer surface 40 of the cuboid-shaped valve block 28 and are fastened there to the valve block 28. The valve block 28 forms channels or pneumatic lines in its interior, which connect the ports 29 to 33 as well as the valves 6 to 8 as well as 10 and 12 to one another.

The supply pressure inlet 29 is connected upstream via the supply line 14 to the compressed air source 9. Downstream, the supply pressure inlet 29 is connected—in particular within the valve block 28—to the towing vehicle supply pressure outlet 30 via the check valve 12. In the reverse flow direction, the check valve 12 isolates the towing vehicle supply pressure outlet 30 from the supply pressure inlet 29. For this purpose, an inlet of the check valve 12 is connected to the supply pressure inlet 29 and an outlet of the check valve 12 to the towing vehicle supply pressure outlet 30. The check valve 12 causes compressed air coming from the compressed air source 9 to flow via the supply pressure inlet 29 and the check valve 12 to the towing vehicle supply pressure outlet 30. On the other hand, compressed air coming from the towing vehicle supply pressure outlet 30 is prevented from flowing via the check valve 12 to the supply pressure inlet 29. The same applies to compressed air coming from the direction of the control valve 6 and the redundancy valve 7. The trailer vehicle supply pressure outlet 31 is connected upstream to the supply pressure inlet 29 by bypassing the check valve 12. Downstream, the trailer vehicle supply pressure outlet is connected to a supply pressure inlet 39 of the trailer control valve system 16 for the trailer brake 3 of the trailer vehicle 4, which is towed by the towing vehicle 2.

The supply pressure inlet 29 is further connected via the check valve 12 to the control valve 6 and to the redundancy valve 7. Within the pneumatic valve arrangement 5, the brake valve 10 is connected upstream on the one hand via the shuttle valve 8 to the control valve 6 and to the redundancy valve 7. Downstream, the brake valve 10 is connected to the towing vehicle control pressure outlet 32. According to FIG. 1, the towing vehicle supply pressure outlet 30 in turn is connected downstream to the supply pressure inlet 20 of the towing vehicle relay valve 11 for actuating the brake cylinder 23 of the towing vehicle 2. By these connections, compressed air from the compressed air source 9 can flow via the control valve 6 or the redundancy valve 7 (depending on which air pressure is greater, one of the two compressed air flows is guided via the shuttle valve 8) and downstream via the brake valve 10 to the towing vehicle control pressure outlet 32.

The towing vehicle control pressure outlet 32 is connected to the control pressure inlet 19 of the towing vehicle relay valve 11 such that the towing vehicle relay valve 11 can be controlled to apply pressure to the brake cylinder 23 and thus also for actuating the parking brakes 24. Furthermore, the trailer vehicle control pressure outlet 33 is also connected upstream via the shuttle valve 8 to the control valve 6 or the redundancy valve 7 such that the higher air pressure is also applied to the trailer vehicle control pressure outlet 33. Downstream, the trailer vehicle control pressure outlet 33 is connected to the first pressure inlet 18 of the trailer control valve system 16 in order to in particular apply pressure to a relay valve of the trailer control valve system 16 for controlling the trailer brake 3. The connections described above can be realized by channels running within the valve block. The check valve 12 can also be integrated into the valve block 28.

It is further provided that all three solenoid valves 6, 7, 10 are actuated as soon as the parking brake system 24 is switched to purge the trailer control valve system 16 and the spring-loaded brake cylinders 23. As a result, either the control valve 6 or the redundancy valve 7 purges the control pressure for the trailer control valve system 16 and the brake valve 10 purges the lines for actuating the relay valve 11 and thus the spring-loaded brakes 23 of the towing vehicle 2. For this purpose, the electronic control unit 25 controls the electromagnet EM1 of the control valve 6 and the redundancy valve 7 such that the control valve 6 and the redundancy valve 7 are transferred to the closed state such that the trailer vehicle control pressure outlet 33 is connected to the non-pressurized environment U via the control valve 6 or the redundancy valve 7. The electronic control unit 25 furthermore controls the electromagnet EM2 of the brake valve 10 such that the brake valve 10 is transferred to the closed state such that the towing vehicle control pressure outlet 32 is likewise connected to the non-pressurized environment U.

In order to further increase the speed of the pressure relief of larger volumes in the spring-loaded brake cylinders 23, a quick purge valve 36 is provided according to the exemplary embodiment according to FIG. 1, which is integrated into the towing vehicle relay valve 11. The quick purge valve 35 is of the one-way type and, similar to a check valve, can be designed with a first inlet (connected to the supply pressure inlet 20 of the towing vehicle relay valve 11) a second inlet (connected to the two brake cylinders 23) and a third inlet (connected to the non-pressurized environment U). The purging action of the quick purge valve 36 is closed as long as the first port is under pressure. However, as soon as the first port is depressurized, the pressure at the second port opens the passage between the second port and the third port (discharge) such that the outlet of the quick purge valve 36 is purged.

### LIST OF REFERENCE SYMBOLS

EM1 Electromagnetic control valve/redundancy valve
EM2 Electromagnet brake valve
HMI Human-machine interface
U Non-pressurized environment
1 Brake system
2 Towing vehicle
3 Trailer brake
4 Trailer vehicle
5 Parking brake module/pneumatic valve arrangement
6 Control valve
7 Redundancy valve
8 Shuttle valve
9 Pressurized medium source
9.1 Compressor
10 Brake valve
11 Towing vehicle relay valve
12 Check valve
13 Wheels
14 Supply line
15 Pressure sensor
16 Trailer control valve system
17 Connection line
18 First inlet trailer control valve system
19 Control pressure inlet towing vehicle relay valve
20 Supply pressure inlet towing vehicle relay valve
21 Pressure outlet towing vehicle relay valve
22 Brake cylinder line
23 Brake cylinder
24 Parking brake
25 Electronic control unit
26 CAN bus
27 Electronic (main) control unit
28 Valve block
29 Supply pressure inlet
30 Towing vehicle supply pressure outlet
31 Trailer vehicle supply pressure outlet
32 Towing vehicle control pressure outlet
33 Trailer vehicle control pressure outlet
34 Lateral outer surface valve block
35 Electronic control lines
36 Quick purge valve
37 Brake pressure outlet
38 Trailer control line
39 Supply pressure inlet trailer control valve system
40 Upper outer surface valve block

1. A pneumatic valve system (5) for a brake system (1) of a towing vehicle (2), the pneumatic valve system (5) comprising:
a valve block (28) comprising a supply pressure inlet (29), a towing vehicle supply pressure outlet (30), and a towing vehicle control pressure outlet (32);
a first directional control valve adapted as a directional control valve (6);
a second directional control valve adapted as a redundancy valve (7); and
a third directional control valve adapted as a brake valve (10);
wherein
the supply pressure inlet (29) is adapted to be connected to a compressed air source (9) of the brake system (1);
the brake valve (10) is firstly connected to the control valve (6) and the redundancy valve (7) via a shuttle valve (8) and secondly to the towing vehicle control pressure outlet (32);
the supply pressure inlet (29) is connected to the control valve (6) and the redundancy valve (7) such that compressed air can flow from the compressed air source (9) via the control valve (6) or the redundancy valve (7) and downstream via the brake valve (10) to the towing vehicle control pressure outlet (32);
the supply pressure inlet (29) is connected to the towing vehicle supply pressure outlet (30);
the towing vehicle supply pressure outlet (30) is adapted to be connected to a supply pressure inlet (20) of a towing vehicle relay valve (11) for actuating a brake cylinder (23) of the towing vehicle (2); and
the towing vehicle control pressure outlet (32) is adapted to be connected to a control pressure inlet (19) of the towing vehicle relay valve (11).

2. The pneumatic valve system (5) according to claim 1, wherein
the valve block (28) comprises a check valve (12);
the check valve (12) connects the supply pressure inlet (29) to the control valve (6) and the redundancy valve (7) such that compressed air can flow from the compressed air source (9) via the control valve (6) or the redundancy valve (7) and downstream via the brake valve (10) to the towing vehicle control pressure outlet (32); and
the check valve (12) connects the supply pressure inlet (29) to the towing vehicle supply pressure outlet (30) and isolates the towing vehicle supply pressure outlet (30) from the supply pressure inlet (29) in the reverse flow direction.

3. The pneumatic valve system (5) according to claim 2, wherein;
the valve block (28) comprises a trailer vehicle supply pressure outlet (31) and a trailer vehicle control pressure outlet (33);
the trailer vehicle supply pressure outlet (31) is connected to the supply pressure inlet (29) by bypassing the check valve (12);
the trailer vehicle supply pressure outlet (31) is adapted to be connected to a supply pressure inlet (39) of a trailer control valve system (16) for a trailer brake (3) of a trailer (4), which is towed by the towing vehicle (2); and
the trailer vehicle control pressure outlet (33) is firstly connected to the control valve (6) and to the redundancy valve (7) via the shuttle valve (8) and is secondly adapted to be connected to a control pressure inlet (18) of the trailer control valve system (16).

4. The pneumatic valve system (5) according to claim 1, wherein the supply pressure inlet (29), the towing vehicle supply pressure outlet (30), the towing vehicle control pressure outlet (32), the trailer vehicle supply pressure outlet (31), and the trailer vehicle control pressure outlet (33) are arranged on the same outer surface (34) of the valve block (28).

5. The pneumatic valve system (5) according to claim 1, the pneumatic valve system (5) further comprising an electronic control unit (25) that is connected via electronic control lines (35) to the control valve (6), the redundancy valve (7), and the brake valve (10), wherein:
the control valve (6), the redundancy valve (7), and the brake valve (10) are solenoid valves,
the solenoid valves (6, 7, 10) each have an electromagnet (EM1, EM2),
the electronic control unit (25) is adapted to control the electromagnets (EM1, EM2) such that
the control valve (6) and the redundancy valve (7) are transferred from a mechanically preloaded closed state to an open state and vice versa, and
the brake valve (10) is transferred from a mechanically preloaded open state to a closed state and vice versa.

6. The pneumatic valve system (5) according to claim 5, wherein the electronic control unit (25)—after having received a brake test request—is adapted to:
control the electromagnets (EM1) of the control valve (6) and the redundancy valve (7) such that the control valve (6) and the redundancy valve (7) are transferred to the open state; and to
control the electromagnets (EM2) of the brake valve (10) such that the brake valve (10) is transferred to the closed state, thus disengaging the trailer brake (3) and engaging the parking brake (24) of the towing vehicle (2).

7. The pneumatic valve system (5) according to claim 5, wherein the electronic control unit (25) is adapted to
control the electromagnets (EM1) of the control valve (6) and the redundancy valve (7) such that the control valve (6) and the redundancy valve (7) are transferred to the closed state such that compressed air cannot flow from the pressurized medium source (9) via the control valve (6) or the redundancy valve (7) and downstream firstly to the trailer vehicle control pressure outlet (33), and secondly via the brake valve (10) to the towing vehicle control pressure outlet (32), thus allowing the parking brake (24) of the towing vehicle (2) and the trailer brake (3) to be engaged, and to
control the electromagnets (EM1) of the control valve (6) and the redundancy valve (7) such that the control valve (6) and the redundancy valve (7) are transferred to the open state such that compressed air can flow from the pressurized medium source (9) via the control valve (6) or the redundancy valve (7) and downstream firstly to the trailer vehicle control pressure outlet (33), and secondly via the brake valve (10) to the towing vehicle control pressure outlet (32), thus allowing the parking brake (24) of the towing vehicle (2) and the trailer brake (3) to be engaged.

8. The pneumatic valve system (5) according to claim 1, wherein the control valve (6), the redundancy valve (7), and the brake valve (10) are identical parts.

9. The pneumatic valve system (5) according to claim 1, wherein the electronic control unit (25) is adapted to
control the electromagnets (EM1) of the control valve (6) and the redundancy valve (7) such that the control valve (6) and the redundancy valve (7) are transferred to the closed state such that the trailer vehicle control pressure outlet (33) is connected via the control valve (6) or the redundancy valve (7) to a non-pressurized environment (U), and to
control the electromagnets (EM2) of the brake valve (10) such that the brake valve (10) is transferred to the closed state such that the towing vehicle control pressure outlet (32) is connected to the non-pressurized environment (U).

10. The pneumatic valve system (5) according to claim 1, wherein a quick purge valve (35) is connected to the towing vehicle relay valve (11), wherein the quick purge valve (35) is adapted to release compressed air directly from the brake cylinder (23) to the non-pressurized environment (U).

11. The pneumatic valve system (5) according to claim 6, wherein the electronic control unit (25) is adapted to
control the electromagnets (EM1) of the control valve (6) and the redundancy valve (7) such that the control valve (6) and the redundancy valve (7) are transferred to the closed state such that compressed air cannot flow from the pressurized medium source (9) via the control valve (6) or the redundancy valve (7) and downstream firstly to the trailer vehicle control pressure outlet (33), and secondly via the brake valve (10) to the towing vehicle control pressure outlet (32), thus allowing the parking brake (24) of the towing vehicle (2) and the trailer brake (3) to be engaged, and to
control the electromagnets (EM1) of the control valve (6) and the redundancy valve (7) such that the control valve (6) and the redundancy valve (7) are transferred to the open state such that compressed air can flow from the pressurized medium source (9) via the control valve (6) or the redundancy valve (7) and downstream firstly to the trailer vehicle control pressure outlet (33), and secondly via the brake valve (10) to the towing vehicle control pressure outlet (32), thus allowing the parking brake (24) of the towing vehicle (2) and the trailer brake (3) to be engaged.

12. The pneumatic valve system (5) according to claim 11, wherein the electronic control unit (25) is adapted to
control the electromagnets (EM1) of the control valve (6) and the redundancy valve (7) such that the control valve (6) and the redundancy valve (7) are transferred to the closed state such that the trailer vehicle control pressure outlet (33) is connected via the control valve (6) or the redundancy valve (7) to a non-pressurized environment (U), and to
control the electromagnets (EM2) of the brake valve (10) such that the brake valve (10) is transferred to the closed state such that the towing vehicle control pressure outlet (32) is connected to the non-pressurized environment (U).

13. The pneumatic valve system (5) according to claim 12, wherein a quick purge valve (35) is connected to the towing vehicle relay valve (11), wherein the quick purge valve (35) is adapted to release compressed air directly from the brake cylinder (23) to the non-pressurized environment (U).

14. The pneumatic valve system (5) according to claim 13, wherein the control valve (6), the redundancy valve (7), and the brake valve (10) are identical parts.
